(19) United States
(12) Patent Application Publication
(10) Pub. No.: US 2026/0106651 A1
(43) Pub. Date: Apr. 16, 2026

(54) CONTROL-PLANE OPTIMIZATION USING ANTENNA MASK

(71) Applicant: QUALCOMM Incorporated, San Diego, CA (US)

(72) Inventors: Abhishek MISHRA, Deoria (IN); Rahul SHARMA, Chirawa (IN); Gaurav SRIVASTAVA, Raebareli (IN); Anil Kumar DEVPURA, Hyderabad (IN)

(21) Appl. No.: 18/912,074

(22) Filed: Oct. 10, 2024

(51) Int. Cl. H04B 7/0456

(52) U.S. Cl. CPC H04B 7/0456

(57) ABSTRACT

The apparatus may be a first network device configured to identify, in a plurality of antennas at a second network device, a first set of activated antennas and a second set of disabled antennas and transmit, to the second network device, an indication of a set of weights, where each weight in the set of weights corresponds to an antenna in the first set of activated antennas and the set of weights does not include a weight corresponding to any antenna in the second set of disabled antennas. The apparatus may be a second network device configured to receive, from the first network device, a first indication of a first set of activated antennas and a second set of disabled antennas in a plurality of antennas at the second network device and receive, from the first network device, the indication of the set of weights.

### TECHNICAL FIELD

The present disclosure relates generally to communication systems, and more particularly, to an open radio access network (O-RAN).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first network device configured to identify, in a plurality of antennas at a second network device, a first set of activated antennas and a second set of disabled antennas and transmit, to the second network device, an indication of a set of weights, where each weight in the set of weights corresponds to an antenna in the first set of activated antennas and the set of weights does not include a weight corresponding to any antenna in the second set of disabled antennas.

In an aspect of the disclosure, a method, a computer-readable medium, and an apparatus are provided. The apparatus may be a first network device configured to receive, from a second network device, a first indication of a first set of activated antennas and a second set of disabled antennas in a plurality of antennas at the first network device and receive, from the second network device, a second indication of a set of weights, where each weight in the set of weights corresponds to an antenna in the first set of activated antennas and the set of weights does not include a weight corresponding to any antenna in the second set of disabled antennas.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an antenna mask applied to a plurality of antenna elements in an antenna array in accordance with some aspects of the disclosure.

FIG. 5 is a call flow diagram illustrating a method of wireless communication in accordance with some aspects of the disclosure.

FIG. 6 is a flowchart of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a diagram illustrating an example of a hardware implementation for an example network entity.

### DETAILED DESCRIPTION

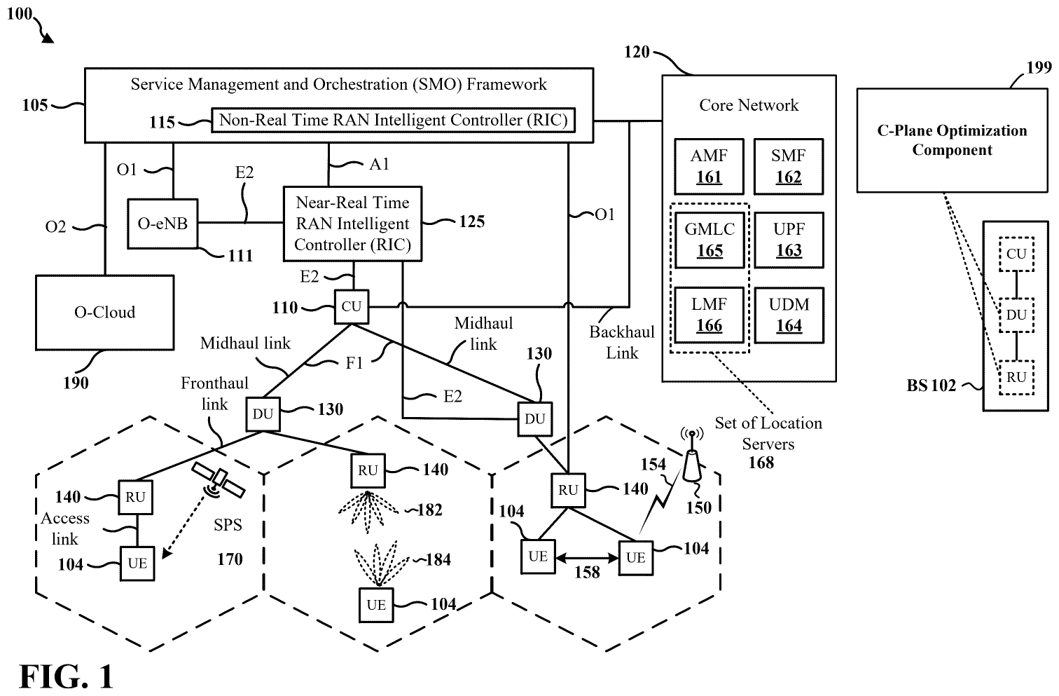

In some aspects of wireless communication associated with a disaggregated base station (described in more detail in relation to FIG. 1 below), a first component of the disaggregated base station (e.g., a distributed unit (DU)) associated with an O-RAN (e.g., an O-RAN DU or O-DU) may indicate and/or provide a set of weights for each antenna element in an array of antenna elements of a second component of the disaggregated base station (e.g., a radio unit (RU)) associated with the O-RAN RU (e.g., an O-RAN RU or O-RU). In addition to indicating and/or providing the set of weights, in some aspects, the O-DU may be capable of (1) indicating to the O-RU a set of disabled antenna elements at the O-RU and/or (2) disabling the set of antenna elements at the O-RU via a control message transmitted to the O-RU. In some aspects indicating disabled antenna elements (or disabling antenna elements), the O-DU may transmit a weight for each element in the array of elements even when some of the elements are disabled (e.g., may include “zero” weights for disabled array elements). This transmission of weights for disabled elements increases a fronthaul load (e.g., an overhead) associated with signaling the weights that is made worse as a number of component carriers (CCs), a number of UEs, and a number of layers associated with communication from the O-RU increases.

Various aspects relate generally to allowing the O-DU to send beamforming weights for activated antenna elements rather than sending weights for all antenna array elements (e.g., sending weights even for the unused and/or disabled antenna array elements). Some aspects more specifically relate to transmitting a limited set of beamforming weights based on a control message identifying the activated and/or disabled antenna array elements (e.g., via an antenna mask (in an antMask[x:0] field) included in a Section Type 4 command type “TRX Control”). In some examples, a first network device may be configured to identify, in a plurality of antennas at a second network device, a first set of activated antennas and a second set of disabled antennas, and transmit, to the second network device, an indication of a set of weights, where each weight in the set of weights corresponds to an antenna in the first set of activated antennas and the set of weights does not include a weight corresponding to any antenna in the second set of disabled antennas. In some aspects, a first network device may be configured to receive, from a second network device, a first indication of a first set of activated antennas and a second set of disabled antennas in a plurality of antennas at the first network device and receive, from the second network device, a second indication of a set of weights, where each weight in the set of weights corresponds to an antenna in the first set of activated antennas and the set of weights does not include a weight corresponding to any antenna in the second set of disabled antennas.

Particular aspects of the subject matter described in this disclosure can be implemented to realize one or more of the following potential advantages. In some examples, by allowing the O-DU to transmit a reduced set of beamforming weights for the O-RU based on an earlier (or associated) control message, the described techniques can be used to significantly reduce a fronthaul load and/or overhead associated with signaling the beamforming weights (and increase a throughput).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 (or a DU 130) may have a control plane (C-plane) optimization component 199 that may be configured to identify, in a plurality of antennas at a second network device, a first set of activated antennas and a second set of disabled antennas and transmit, to the second network device, an indication of a set of weights, where each weight in the set of weights corresponds to an antenna in the first set of activated antennas and the set of weights does not include a weight corresponding to any antenna in the second set of disabled antennas. In some aspects, the base station 102 (or an RU 140) may have a C-plane optimization component 199 that may be configured to receive, from a first network device, a first indication of a first set of activated antennas and a second set of disabled antennas in a plurality of antennas at the second network device and receive, from the first network device, a second indication of a set of weights, where each weight in the set of weights corresponds to an antenna in the first set of activated antennas and the set of weights does not include a weight corresponding to any antenna in the second set of disabled antennas. Although the following description may be focused on 5G NR, the concepts described herein may be applicable to other similar areas, such as LTE, LTE-A, CDMA, GSM, and other wireless technologies.

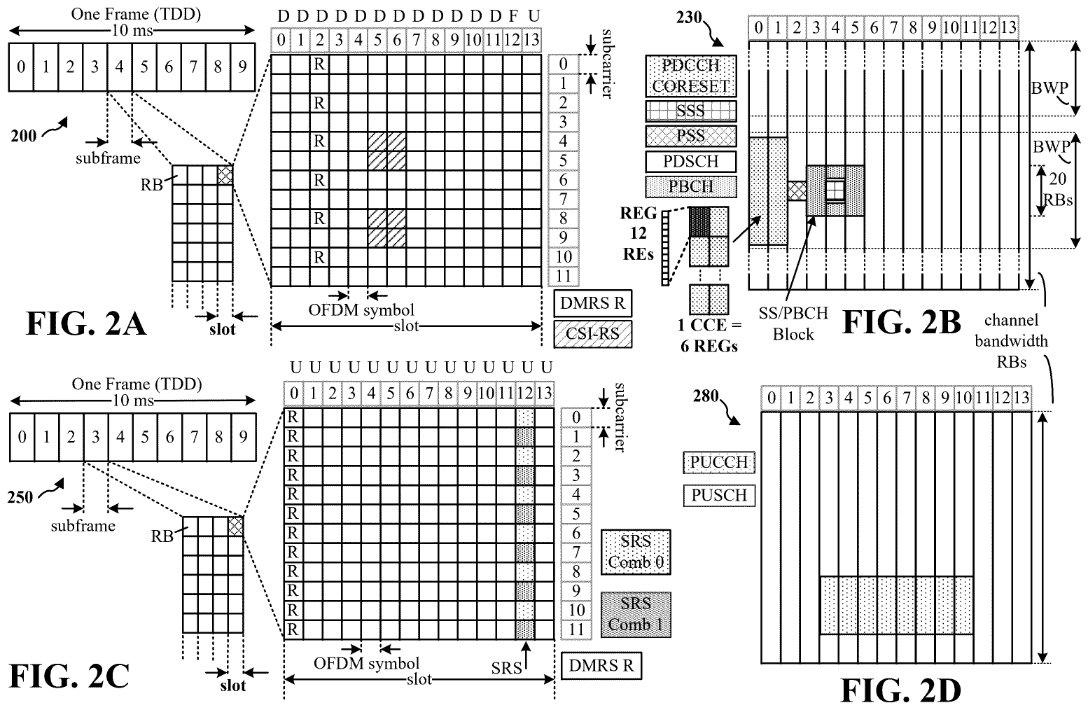

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

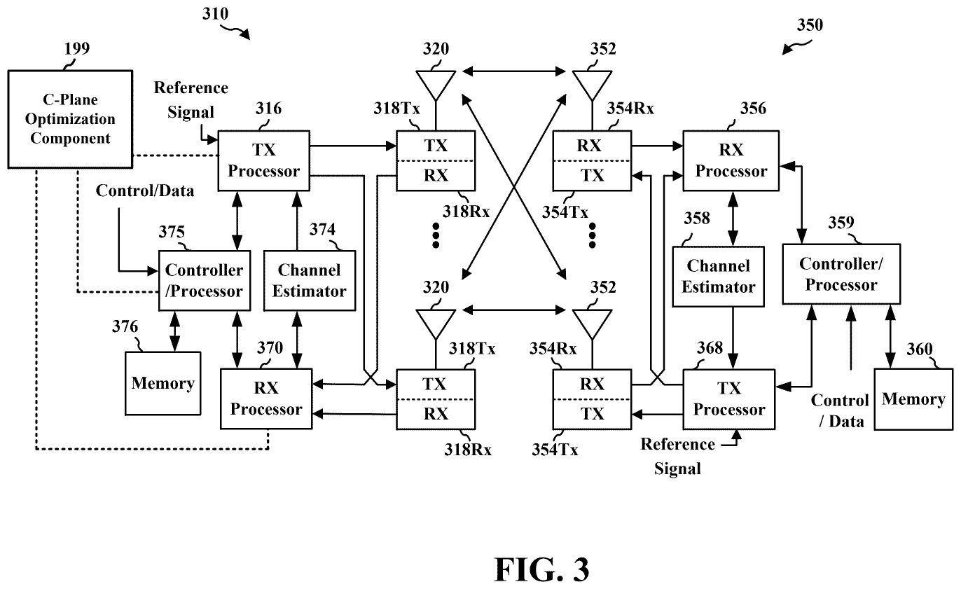

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer I functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the C-plane optimization component 199 of FIG. 1.

In some aspects of wireless communication, the O-DU may indicate and/or provide a set of weights for each (configurable) antenna element in an array of (configurable) antenna elements of an O-RAN RU (O-RU). The weights, in some aspects, may be a set of beamforming weights and/or coefficients associated with an in-phase (I) component and a quadrature (Q) component of a transmitted signal and may be applied at an RF chain associated with a corresponding antenna transmitting the signal. Each indicated weight, in some aspects, may be indicated by multiple bits (e.g., 2 bytes for the I component and 2 bytes for the Q component). In addition to indicating and/or providing the set of weights, in some aspects, the O-DU may be capable of (1) indicating to the O-RU a set of disabled antenna elements at the O-RU and/or (2) disabling the set of antenna elements at the O-RU via a control message transmitted to the O-RU. For example, a control message may include a field (e.g., the Section Type 4 Command Type “TRX CONTROL” including the antMask[x:0] field illustrated in Table 2) indicating whether each of a plurality of antennas in an antenna array of an O-RU is in an activated/disabled (or On/Off) state. The field indicating whether each of the plurality of antennas in the antenna array of the O-RU is in an activated/disabled (or On/Off) state, in some aspects, may be a bitmap with a length equal to the number of antennas in the antenna array (e.g., in the plurality of antennas).

TABLE 2
Section Type 4 Command Type “TRX CONTROL”

| | | | | | | | | # of |
|---|---|---|---|---|---|---|---|---|
| 0 (msb) | 1 | 2 | 3 | 4 | 5 | 6 | 7 (lsb) | bytes |

| transport header | | | 8 |
|---|---|---|---|
| Section Type 4 section header | | | 8 |
| Section Type 4 common part of the command header | | | 8 |
| reserved | log2MaskBits[3:0] | sleepMode[1:0] | 1 |

| | | |
|---|---|---|
| reserved | numSlotsExt[19:16] | 1 |

| numSlotsExt[15:8] | | 1 |
|---|---|---|
| numSlotsExt[7:0] | | 1 |
| reserved | symbolMask[13:8] | 1 |

| | |
|---|---|
| symbolMask[7:0] | 1 |
| antMask[x:0] | var |
| zero-pad to a 4 byte boundary, not always present | |

In some aspects indicating disabled antenna elements (or disabling antenna elements), the O-DU may transmit a weight for each element in the array of elements even when some of the elements are disabled (e.g., may include “zero” weights for disabled array elements). This transmission of weights for disabled elements increases a fronthaul load (e.g., an overhead) associated with signaling the weights that is made worse as the number of component carriers (CCs), the number of UEs, and the number of layers associated with communication from the O-RU increases.

Various aspects relate generally to allowing the O-DU to send beamforming weights for activated antenna elements rather than sending weights for all antenna array elements, even the unused and/or disabled antenna array elements. Some aspects more specifically relate to transmitting a limited set of beamforming weights based on a control message identifying the activated and/or disabled antenna array elements (e.g., via an antenna mask (in an antMask[x:0] field) included in a Section Type 4 command type “TRX Control”). In some examples, a first network device may be configured to identify, in a plurality of antennas at a second network device, a first set of activated antennas and a second set of disabled antennas and transmit, to the second network device, an indication of weights for the plurality of antennas including a set of weights, where each weight in the set of weights corresponds to an antenna in the first set of activated antennas and the set of weights does not include a weight corresponding to any antenna in the second set of disabled antennas. In some aspects, the second network device may be configured to receive, from the first network device, a first indication of a first set of activated antennas and a second set of disabled antennas in a plurality of antennas at the second network device and receive, from the first network device, a second indication of weights for the plurality of antennas including a set of weights, where each weight in the set of weights corresponds to an antenna in the first set of activated antennas and the set of weights does not include a weight corresponding to any antenna in the second set of disabled antennas.

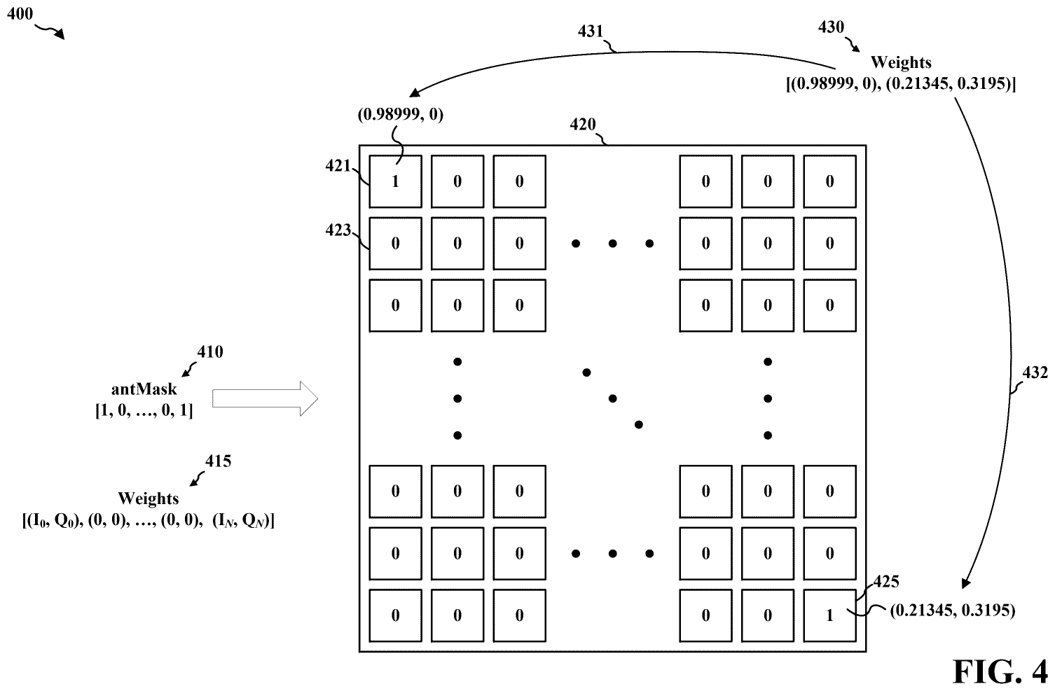

FIG. 4 is a diagram 400 illustrating an antenna mask applied to a plurality of antenna elements in an antenna array in accordance with some aspects of the disclosure. Diagram 400 illustrates an antenna array 420 of “N” configurable antenna elements. In some aspects, each configurable antenna element may be associated with one of a corresponding number (N) of RF chains that may apply beamforming weights for a transmitted signal and/or to transmit a signal to a target device. The O-DU, in some aspects, may transmit an indication 410 of whether each antenna in the array of configurable antenna elements is activated or is disabled (or in an On or Off state). In some aspects, the indication 410 may be via an antMask field of a Section Type 4 command type “TRX Control.” The antMask, in some aspects, may be a bitmap with N elements (e.g., bits) using a first value (e.g., “1” in the example of FIG. 4) to indicate an activation of a corresponding antenna (e.g., that the corresponding antenna is active) and using a second value (e.g., “0” in the example of FIG. 4) to indicate a disabling of a corresponding antenna (e.g., that the corresponding antenna is disabled). For example, the indication 410 may include the first value (“1”) for a first bit and a last bit with all other bits being set equal to the second value (“0”) to indicate that a first corresponding antenna 421 and a last (or Nth) corresponding antenna 425 are activated while all the other antenna (e.g., antenna 423) are disabled or not activated.

In some aspects not allowing the O-DU to transmit beamforming weights for activated antenna element, an O-DU may send a full set of beamforming weights 415 including a value for an I component and a Q component for each of the N antennas of the antenna array 420, where each beamforming weight for a disabled antenna is set to 0 (e.g., 0 for the I component and 0 for the Q component). If, for example, each weight is indicated by two bytes (e.g., 2 bytes for I and 2 bytes for Q), the full set of beamforming weights 415 may include N*4 bytes. The number of beamforming weights will increase for each layer, target device (e.g., a UE), and/or CC for which the beamforming weights are separately indicated. However, in aspects allowing the O-DU to transmit beamforming weights for activated antenna elements, the O-DU may transmit the (limited) set of beamforming weights 430 including two beamforming weights (e.g., beamforming weight 431 and beamforming weight 432) for the first corresponding antenna 421 and the last (or Nth) corresponding antenna 425. Based on the reduced number of beamforming weights, the number of bytes transmitted to indicate the beamforming weights may be significantly reduced.

For example, for an antenna array including 64 antenna elements, if the beamforming weights transmitted by the O-DU are associated with 1 UE (e.g., 1 target device or beam direction), 1 CC, and 1 layer, a full set of beamforming weights may be associated with a size of 302 bytes while a set of beamforming weights for a set of 32, 16, 8, or 1 activated antennas may be associated with a size of 174, 110, 78, and 50 bytes, respectively (based on a common set of 46 bytes plus 4 bytes per antenna). Adding additional target devices/beam directions, CCs, and or layers, in some aspects, may increase the number of bytes associated with the transmission of the beamforming linearly with the number of combinations of target device/beam direction, CC, and layer. For example, if the number of each of the target devices/beam directions, CCs and layers is increased by a factor of 2 (e.g., for 2 UEs/beam directions, 2 CCs, and 2 layers), the number of bytes associated with the transmission of the beamforming weights may increase by a factor of 8. The reduced size of the transmitted beamforming weights, in some aspects, may result in a corresponding increase in throughput (e.g., bytes not used for configuring and/or indicating the beamforming weights may be used to transmit data instead).

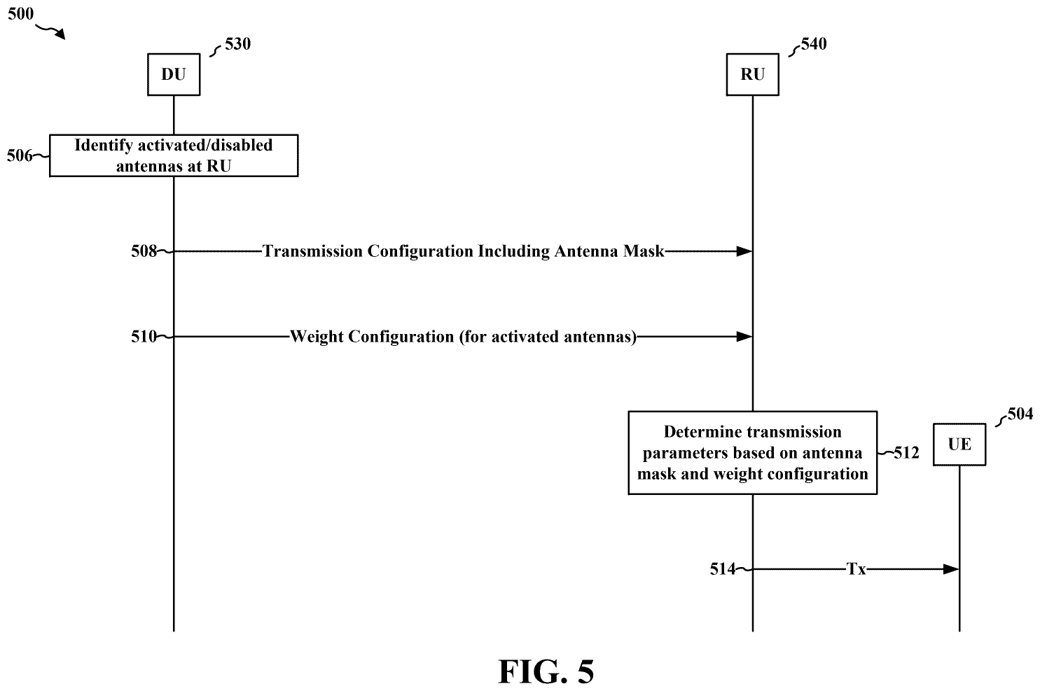

FIG. 5 is a call flow diagram 500 illustrating a method of wireless communication in accordance with some aspects of the disclosure. The method is illustrated in relation to a DU 530 and a RU 540 (e.g., as examples of network devices or network nodes) where the RU 540 is in communication with a UE 504 (e.g., as an example of a wireless device). In some aspects, the DU 530 may be an O-DU and the RU 540 may be an O-RU. The functions ascribed to the DU 530 and the RU 540, in some aspects, may be performed by one or more components of a network entity, a network node, or a network device (a single network entity/node/device or a disaggregated network entity/node/device as described above in relation to FIG. 1). Similarly, the functions ascribed to the UE 504, in some aspects, may be performed by one or more components of a wireless device supporting communication with a network entity/node/device. Accordingly, references to “transmitting” in the description below may be understood to refer to a first component of the DU 530 and the RU 540 (or the UE 504) outputting (or providing) an indication of the content of the transmission to be transmitted by a different component of the DU 530 and the RU 540 (or the UE 504). Similarly, references to “receiving” in the description below may be understood to refer to a first component of the DU 530 and the RU 540 (or the UE 504) receiving a transmitted signal and outputting (or providing) the received signal (or information based on the received signal) to a different component of the DU 530 and the RU 540 (or the UE 504).

At 506, the DU 530 may identify and or determine a set of activated and/or disabled antennas in a plurality of antennas in an antenna array at the RU 540. Based on the identification and/or determination at 506, the DU 530 may transmit, and the RU 540 may receive, a transmission configuration 508 that includes an indication of a first set of activated antennas and a second set of disabled antennas. In some aspects, the transmission configuration 508 may be a control message (e.g., the Section Type 4 command type “TRX Control” message) associated with a control plane (C-plane). In some aspects, the indication of the first set of activated antennas and the second set of disabled antennas may be (or include) a bitmap corresponding to the plurality of antennas, where for each bit in the bitmap, a first value (e.g., “1” or “0”) indicates that a corresponding antenna is an active antenna in the first set of activated antennas, and a second value (e.g., “0” or “1”) indicates that the corresponding antenna is a disabled antenna in the second set of disabled antennas.

Based on the transmission configuration 508, the DU 530 may transmit, and the RU 540 may receive, a weight configuration 510 including an indication of a set of weights. In some aspects, each weight in the set of weights may correspond to an antenna in the first set of activated antennas and the set of weights may not include a weight corresponding to (any) antennas in the second set of disabled antennas. The indication of the set of weights may include, or be, an ordered set of weights corresponding to bits in the bitmap having the first value (e.g., bits in the indication of the first set of activated antennas and the second set of disabled antennas indicating activated antennas). In some aspects, the transmission configuration 508 and the weight configuration 510 may be included in a same control message or a same transmission.

Based on the transmission configuration 508 and the weight configuration 510, the RU 540 may, at 512, determine a set of transmission parameters for a transmission 514 to a UE 504. For example, in some aspects, the RU 540 may determine the first set of activated antennas based on the transmission configuration 508 and then apply the weights in the set weights in the weight configuration 510 in the order that they were provided. In some aspects, the RU 540 may use an algorithm to match activated antennas and weights in the set of weights in the weight configuration 510. For example, the algorithm may begin by initializing a set of index variables (e.g., and index value i into the bitmap and an index value j into the set of weights) to 0. The algorithm may then determine if the i^{th} term of the bitmap indicates an activated antenna. If the i^{th} term of the bitmap indicates that the antenna is activated, the algorithm may apply/assign (or associate) the j^{th} term in the set of weights (e.g., an I and Q weight pair) to (or with) the antenna corresponding to the i^{th} term of the bitmap and increment the value of j (to an index associated with a next weight in the set of weights) and increment the value of i (to an index associated with a next bit in the bitmap). If the i^{th} term of the bitmap indicates that the antenna is disabled, the algorithm may increment the value i and return to determine if the (updated) i^{th} term of the bitmap indicates an activated antenna until the maximum value for i (e.g., an index value associated with a last bit in the bitmap) has been reached (and a determination has been made for whether an antenna corresponding to the last bit is activated).

In some aspects, the RU 540 may, before incrementing the value of j, determine whether a current value of j is a maximum value of j (e.g., jₘₐₓ, where jₘₐₓ may be a last index into the set of weights). If j is the maximum value (e.g., if j=jₘₐₓ indicating that there are no more weights and/or corresponding activated antennas associated with the transmission), the RU 540 may terminate the algorithm and proceed to transmit transmission 514 based on the weights assigned to, associated with, or applied to the activated antennas. If, however, the RU 540 determines that the current value of j is less than jₘₐₓ, the RU 540 may increment the value of j and proceed as described above. While one variant of the algorithm is discussed above, in some aspects, other algorithms or methods may be used that allow the RU 540 to match activated antennas identified in the transmission configuration 508 with weights in the set of weights included in the weight configuration 510. Based on the determined weights, the RU 540 may transmit, and the UE 504 may receive, a transmission 514.

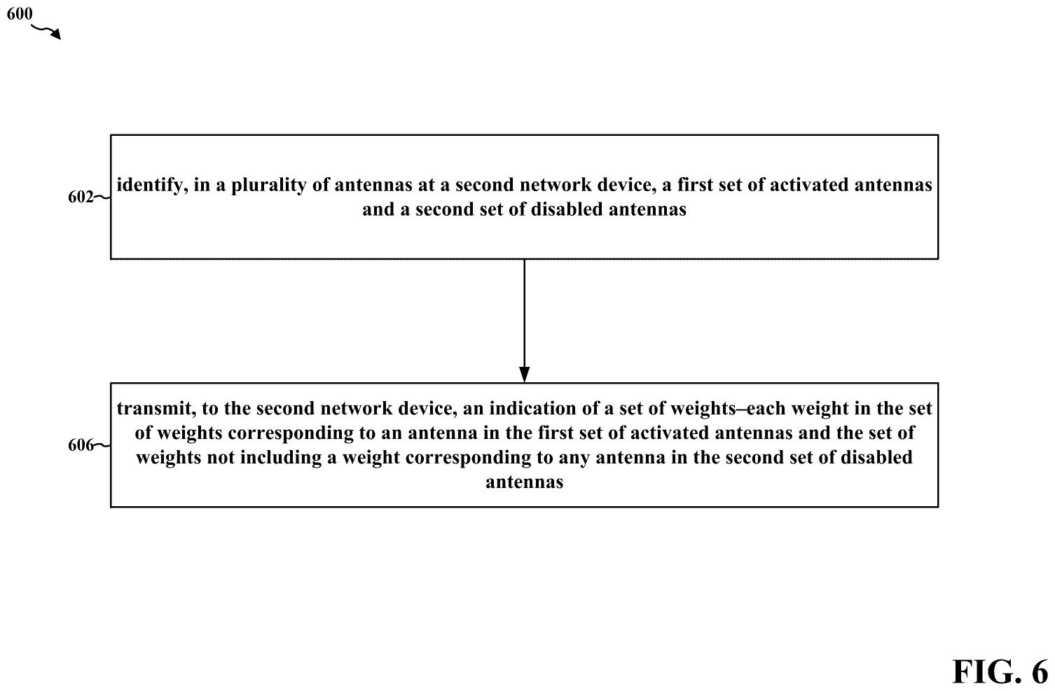

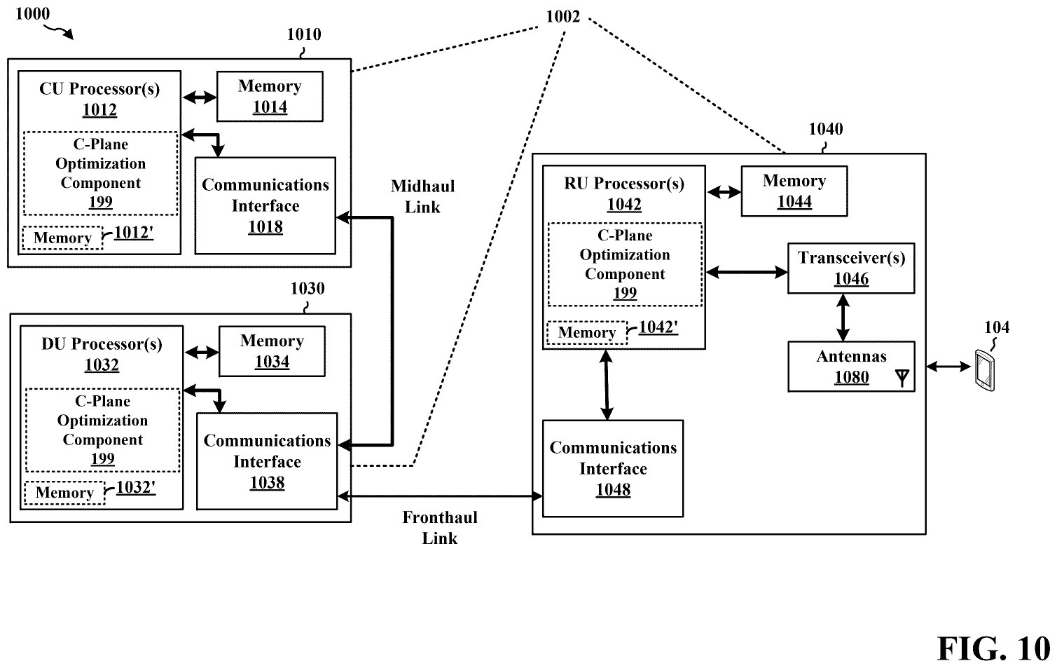

FIG. 6 is a flowchart 600 of a method of wireless communication. The method may be performed by a DU component of a disaggregated base station as an example of a first network device (e.g., the DU of base station 102; the DU 130, 530, 1030; the network entity 1002). At 602, the DU may identify, in a plurality of antennas at a second network device, a first set of activated antennas and a second set of disabled antennas. For example, 602 may be performed by DU processor(s) 1032, transceiver(s) 1046, antenna(s) 1080, and/or C-plane optimization component 199 of FIG. 10. In some aspects, the first network device may be an O-DU and the second network device may be O-RU. For example, referring to FIG. 5, the DU 530, at 506, may identify and or determine a set of activated and/or disabled antennas in a plurality of antennas in an antenna array at the RU 540.

In some aspects, the DU may transmit, to the second network device, a (first and/or prior) indication of the first set of activated antennas and the second set of disabled antennas. In some aspects, the (first/prior) indication of the first set of activated antennas and the second set of disabled antennas may be an antenna mask. The (first/prior) indication, in some aspects, may include, or be, a bitmap corresponding to the plurality of antennas, where for, or at, each bit in the bitmap, the bit having a first value indicates that a corresponding antenna is an active antenna in the first set of activated antennas, and the bit having a second value indicates that the corresponding antenna is a disabled antenna in the second set of disabled antennas. In other words, a first value, for each bit in the bitmap, indicates that a corresponding antenna is an active antenna in the first set of activated antennas, and a second value, for each bit in the bitmap, indicates that the corresponding antenna is a disabled antenna in the second set of disabled antennas. The (first/prior) indication, in some aspects, may be included in a control message associated with a control plane. For example, referring to FIG. 5, the DU 530 may transmit, and the RU 540 may receive, the transmission configuration 508 that includes an indication of a first set of activated antennas and a second set of disabled antennas.

At 606, the DU may transmit, to the second network device, an indication (e.g., a second and/or subsequent indication) of a set of weights. In some aspects, each weight in the set of weights may correspond to an antenna in the first set of activated antennas and the set of weights may not include a weight corresponding to any antenna in the second set of disabled antennas. For example, 606 may be performed by DU processor(s) 1032, transceiver(s) 1046, antenna(s) 1080, and/or C-plane optimization component 199 of FIG. 10. In some aspects, the indication of the set of weights may be based on the (first/prior) indication. The weights in the set of weights, in some aspects, may be weight pairs associated with a corresponding antenna (or RF chain). For example, each weight in the set of weights, in some aspects, may include, or be, (a weight pair including) an in-phase (I) weight and a quadrature (Q) weight associated with a corresponding antenna in the first set of activated antennas. In some aspects, the weights may be beamforming weights. The indication of the set of weights, in some aspects, may have a size based on a number of antennas in the first set of activated antennas indicated in the (first/prior) indication. For example, the number of weights (or weight pairs) included in the indication of the set of weights may be equal to the number of activated antennas. In some aspects, the indication of the set of weights may be associated with the control message including the (first/prior) indication of the activated/disabled antennas. The indication of the set of weights, in some aspects, may include, or be, an ordered set of weights corresponding to bits in the bitmap (included in the indication of the activated/disabled antennas) having a first value indicating an activated antenna. For example, referring to FIG. 5, the DU 530 may transmit, and the RU 540 may receive, the weight configuration 510 including an indication of a set of weights, where, in some aspects, each weight in the set of weights corresponds to an antenna in the first set of activated antennas and the set of weights does not include a weight corresponding to (any) antennas in the second set of disabled antennas.

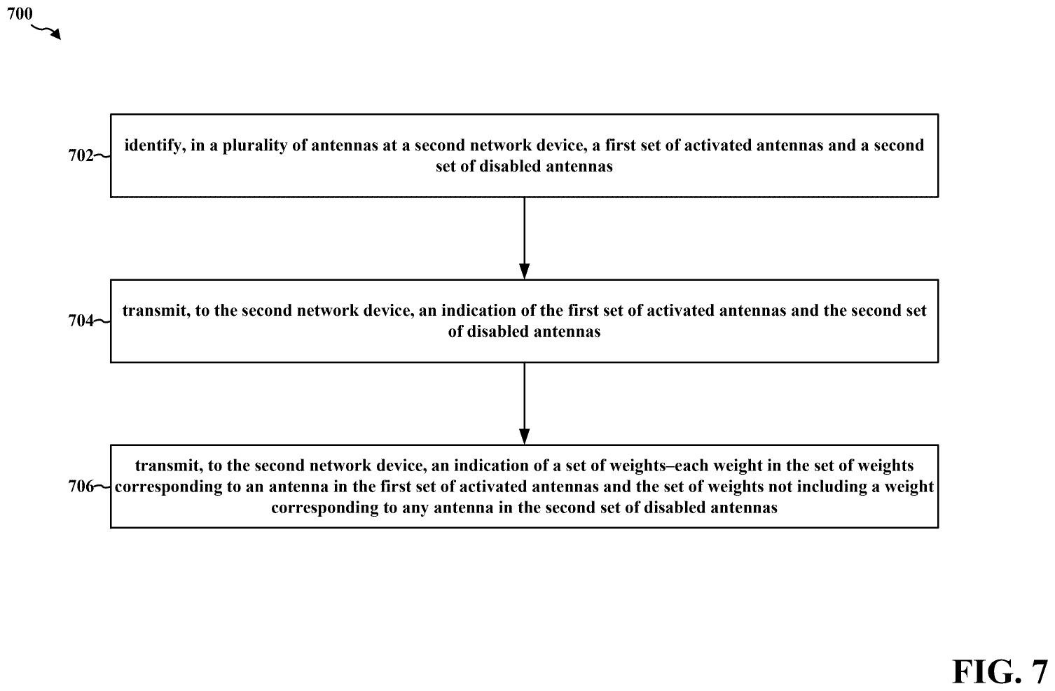

FIG. 7 is a flowchart 700 of a method of wireless communication. The method may be performed by a DU component of a disaggregated base station as an example of a first network device (e.g., the DU of base station 102; the DU 130, 530, 1030; the network entity 1002). At 702, the DU may identify, in a plurality of antennas at a second network device, a first set of activated antennas and a second set of disabled antennas. For example, 702 may be performed by DU processor(s) 1032, transceiver(s) 1046, antenna(s) 1080, and/or C-plane optimization component 199 of FIG. 10. In some aspects, the first network device may be an O-DU and the second network device may be O-RU. For example, referring to FIG. 5, the DU 530, at 506, may identify and or determine a set of activated and/or disabled antennas in a plurality of antennas in an antenna array at the RU 540.

At 704, the DU may transmit, to the second network device, a (first and/or prior) indication of the first set of activated antennas and the second set of disabled antennas. For example, 704 may be performed by DU processor(s) 1032, transceiver(s) 1046, antenna(s) 1080, and/or C-plane optimization component 199 of FIG. 10. In some aspects, the (first/prior) indication of the first set of activated antennas and the second set of disabled antennas may be an antenna mask. The (first/prior) indication, in some aspects, may include, or be, a bitmap corresponding to the plurality of antennas, where for, or at, each bit in the bitmap, the bit having a first value indicates that a corresponding antenna is an active antenna in the first set of activated antennas, and the bit having a second value indicates that the corresponding antenna is a disabled antenna in the second set of disabled antennas. In other words, a first value, for each bit in the bitmap, indicates that a corresponding antenna is an active antenna in the first set of activated antennas, and a second value, for each bit in the bitmap, indicates that the corresponding antenna is a disabled antenna in the second set of disabled antennas. The (first/prior) indication, in some aspects, may be included in a control message associated with a control plane. For example, referring to FIG. 5, the DU 530 may transmit, and the RU 540 may receive, the transmission configuration 508 that includes an indication of a first set of activated antennas and a second set of disabled antennas.

At 706, the DU may transmit, to the second network device, an indication (e.g., a second and/or subsequent indication) of a set of weights. In some aspects, each weight in the set of weights may correspond to an antenna in the first set of activated antennas and the set of weights may not include a weight corresponding to any antenna in the second set of disabled antennas. For example, 706 may be performed by DU processor(s) 1032, transceiver(s) 1046, antenna(s) 1080, and/or C-plane optimization component 199 of FIG. 10. In some aspects, the indication of the set of weights is based on the (first/prior) indication transmitted at 704. The weights in the set of weights, in some aspects, may be weight pairs associated with a corresponding antenna (or RF chain). For example, each weight in the set of weights, in some aspects, may include, or be, (a weight pair including) an in-phase (I) weight and a quadrature (Q) weight associated with a corresponding antenna in the first set of activated antennas. In some aspects, the weights may be beamforming weights. The indication of the set of weights, in some aspects, may have a size based on a number of antennas in the first set of activated antennas indicated in the (first/prior) indication transmitted at 704. For example, the number of weights (or weight pairs) included in the indication of the set of weights may be equal to the number of activated antennas. In some aspects, the indication of the set of weights may be associated with the control message including the (first/prior) indication of the activated/disabled antennas. The indication of the set of weights, in some aspects, may include, or be, an ordered set of weights corresponding to bits in the bitmap (included in the indication of the activated/disabled antennas) having a first value indicating an activated antenna. For example, referring to FIG. 5, the DU 530 may transmit, and the RU 540 may receive, the weight configuration 510 including an indication of a set of weights, where, in some aspects, each weight in the set of weights corresponds to an antenna in the first set of activated antennas and the set of weights does not include a weight corresponding to (any) antennas in the second set of disabled antennas.

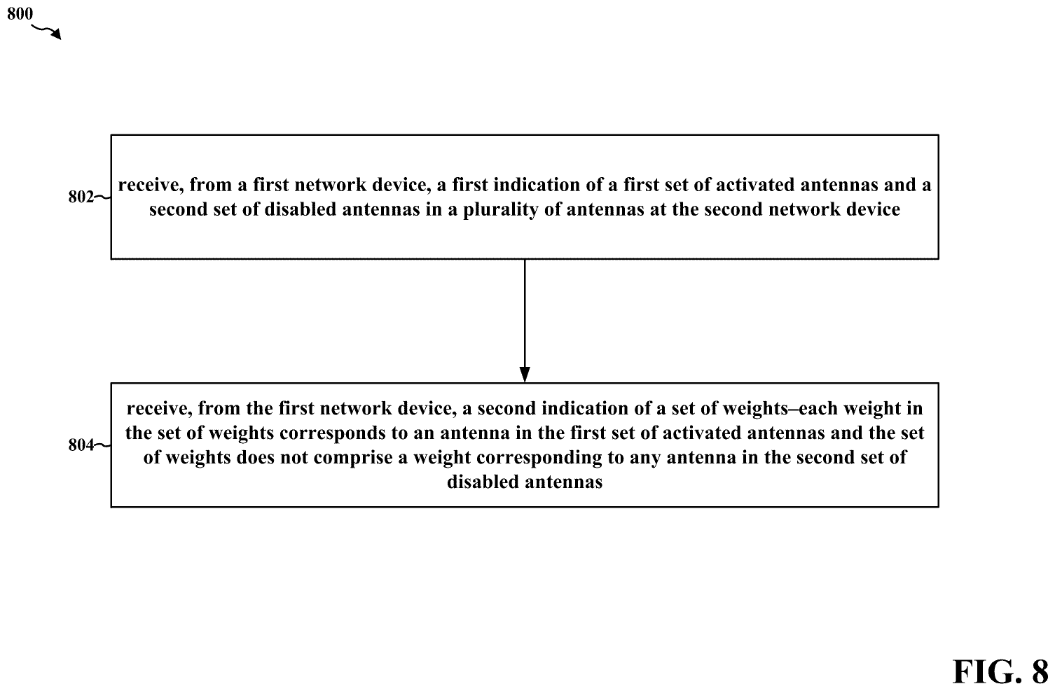

FIG. 8 is a flowchart 800 of a method of wireless communication. The method may be performed by a RU component of a disaggregated base station as an example of a first network device (e.g., the RU of base station 102; the RU 140, 540, 1040; the network entity 1002). At 802, the RU may receive, from a second network device, a first indication of a first set of activated antennas and a second set of disabled antennas in a plurality of antennas at the RU. For example, 802 may be performed by RU processor(s) 1042, transceiver(s) 1046, antenna(s) 1080, and/or C-plane optimization component 199 of FIG. 10. In some aspects, the first indication of the first set of activated antennas and the second set of disabled antennas may be an antenna mask. The first indication, in some aspects, may include, or be, a bitmap corresponding to the plurality of antennas, where for, or at, each bit in the bitmap, a first value indicates that a corresponding antenna is an active antenna in the first set of activated antennas, and a second value indicates that the corresponding antenna is a disabled antenna in the second set of disabled antennas. In other words, a first value, for each bit in the bitmap, indicates that a corresponding antenna is an active antenna in the first set of activated antennas, and a second value, for each bit in the bitmap, indicates that the corresponding antenna is a disabled antenna in the second set of disabled antennas. The first indication, in some aspects, may be included in a control message associated with a control plane. In some aspects, the first network device may be an O-RU and the second network device may be O-DU. For example, referring to FIG. 5, the RU 540 may receive, and the DU 530 may transmit, the transmission configuration 508 that includes an indication of a first set of activated antennas and a second set of disabled antennas.

At 804, the RU may receive, from the second network device, an indication of a set of weights. In some aspects, each weight in the set of weights may correspond to an antenna in the first set of activated antennas and the set of weights may not include a weight corresponding to any antenna in the second set of disabled antennas. For example, 804 may be performed by, RU processor(s) 1042, transceiver(s) 1046, antenna(s) 1080, and/or C-plane optimization component 199 of FIG. 10. In some aspects, the indication of the set of weights may be based on the first indication received at 802. The weights in the set of weights, in some aspects, may be weight pairs associated with a corresponding antenna (or RF chain). For example, each weight in the set of weights, in some aspects, may include, or be, (a weight pair including) an in-phase (I) weight and a quadrature (Q) weight associated with a corresponding antenna in the first set of activated antennas. In some aspects, the weights may be beamforming weights. The indication of the set of weights, in some aspects, may have a size based on a number of antennas in the first set of activated antennas indicated in the first indication received at 802. For example, the number of weights (or weight pairs) included in the indication of the set of weights may be equal to the number of activated antennas. In some aspects, the indication of the set of weights may be associated with the control message including the first indication of the activated/disabled antennas. The indication of the set of weights, in some aspects, may include, or be, an ordered set of weights corresponding to bits in the bitmap (included in the indication of the activated/disabled antennas) having a first value indicating an activated antenna. For example, referring to FIG. 5, the RU 540 may receive, and the DU 530 may transmit, the weight configuration 510 including an indication of a set of weights, where, in some aspects, each weight in the set of weights corresponds to an antenna in the first set of activated antennas and the set of weights does not include a weight corresponding to (any) antennas in the second set of disabled antennas.

In some aspects, the RU may transmit, based on the first indication and the second indication, a signal to a target wireless device. Transmitting the signal, in some aspects, may include applying the weight(s) in the second indication of the set of weights to the corresponding antenna(s) in the first set of activated antennas when transmitting the signal. For example, referring to FIG. 5, the RU 540 may transmit transmission 514 to the UE 504 based on a determination, at 512, of a set of transmission parameters for the transmission to the UE 504.

In some aspects, applying the weight(s) may include a process for identifying activated antennas and the corresponding weights indicated in the first and second indication. For example, the RU may begin the process by initializing a set of index variables (e.g., and index value i into the bitmap and an index value j into the set of weights) to 0. The RU may then determine if the i^{th} term of the bitmap indicates an activated antenna. If the RU determines that the i^{th} term of the bitmap indicates that the antenna is activated, the RU may apply/assign (or associate) the j^{th} term in the set of weights (e.g., an I and Q weight pair) to (or with) the antenna corresponding the antenna corresponding to the i^{th} term of the bitmap and increment the value of j. The RU may then determine if index value i has reached a maximum value and, if the RU determines that the index value i has reached the maximum value, the RU may end the process having identified all the activated antennas and the corresponding weights in the set of weights. If the RU determines that the i^{th} term of the bitmap indicates that the antenna is disabled or determines that the index value i has not reached the maximum value, the RU may increment the value i and return to determine if the i^{th} term of the bitmap indicates an activated antenna until the maximum value for i has been assessed. In some aspects, other algorithms, processes, or methods may be used that allow the RU to match activated antennas identified in the first indication with weights in the set of weights included in (or indicated by) the second indication of the set of weights. For example, referring to FIG. 5, the RU 540 may determine, at 512, of a set of transmission parameters for the transmission 514 to the UE 504 based on the algorithm described in relation to FIG. 5, and based on the determined weights, the RU 540 may transmit, and the UE 504 may receive, a transmission 514.

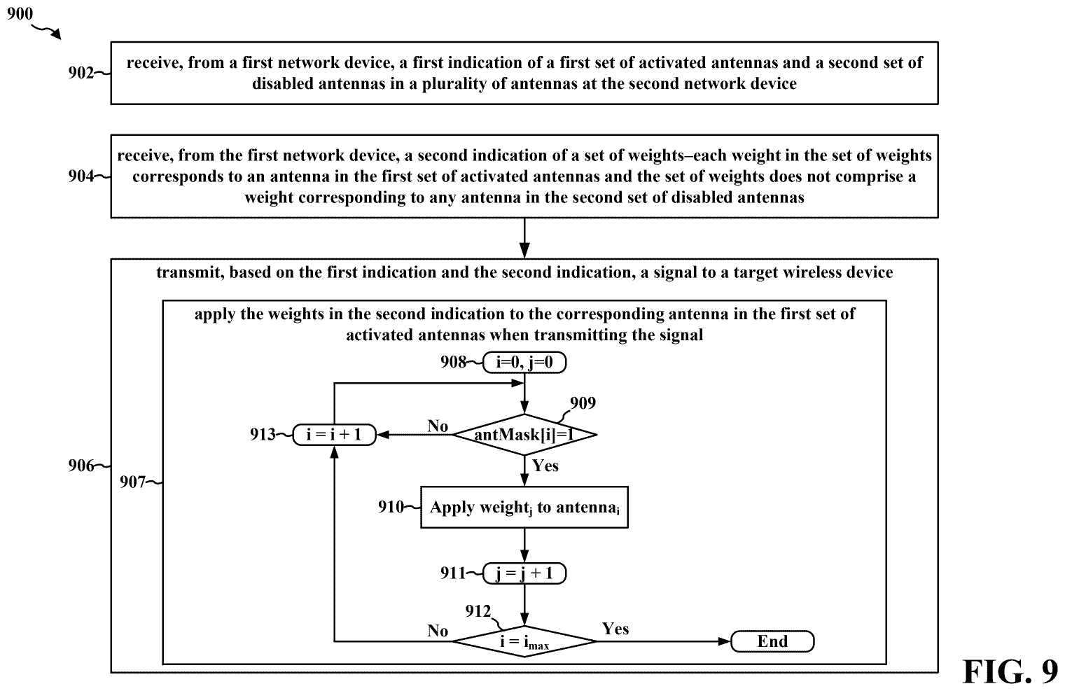

FIG. 9 is a flowchart 900 of a method of wireless communication. The method may be performed by a RU component of a disaggregated base station as an example of a first network device (e.g., the RU of base station 102; the RU 140, 540, 1040; the network entity 1002). At 902, the RU may receive, from a second network device, a first indication of a first set of activated antennas and a second set of disabled antennas in a plurality of antennas at the RU. For example, 902 may be performed by RU processor(s) 1042, transceiver(s) 1046, antenna(s) 1080, and/or C-plane optimization component 199 of FIG. 10. In some aspects, the first indication of the first set of activated antennas and the second set of disabled antennas may be an antenna mask. The first indication, in some aspects, may include, or be, a bitmap corresponding to the plurality of antennas, where for each bit in the bitmap, a first value indicates that a corresponding antenna is an active antenna in the first set of activated antennas, and a second value indicates that the corresponding antenna is a disabled antenna in the second set of disabled antennas. In other words, a first value, for each bit in the bitmap, indicates that a corresponding antenna is an active antenna in the first set of activated antennas, and a second value, for each bit in the bitmap, indicates that the corresponding antenna is a disabled antenna in the second set of disabled antennas. The first indication, in some aspects, may be included in a control message associated with a control plane. In some aspects, the first network device may be an O-RU and the second network device may be O-DU. For example, referring to FIG. 5, the RU 540 may receive, and the DU 530 may transmit, the transmission configuration 508 that includes an indication of a first set of activated antennas and a second set of disabled antennas.

At 904, the RU may receive, from the second network device, an indication of a set of weights. In some aspects, each weight in the set of weights may correspond to an antenna in the first set of activated antennas and the set of weights may not include a weight corresponding to any antenna in the second set of disabled antennas. For example, 904 may be performed by, RU processor(s) 1042, transceiver(s) 1046, antenna(s) 1080, and/or C-plane optimization component 199 of FIG. 10. In some aspects, the indication of the set of weights may be based on the first indication received at 902. The weights in the set of weights, in some aspects, may be weight pairs associated with a corresponding antenna (or RF chain). For example, each weight in the set of weights, in some aspects, may include, or be, (a weight pair including) an in-phase (I) weight and a quadrature (Q) weight associated with a corresponding antenna in the first set of activated antennas. In some aspects, the weights may be beamforming weights. The indication of the set of weights, in some aspects, may have a size based on a number of antennas in the first set of activated antennas indicated in the first indication received at 902. For example, the number of weights (or weight pairs) included in the indication of the set of weights may be equal to the number of activated antennas. In some aspects, the indication of the set of weights may be associated with the control message including the first indication of the activated/disabled antennas. The indication of the set of weights, in some aspects, may include, or be, an ordered set of weights corresponding to bits in the bitmap (included in the indication of the activated/disabled antennas) having a first value indicating an activated antenna. For example, referring to FIG. 5, the RU 540 may receive, and the DU 530 may transmit, the weight configuration 510 including an indication of a set of weights, where, in some aspects, each weight in the set of weights corresponds to an antenna in the first set of activated antennas and the set of weights does not include a weight corresponding to (any) antennas in the second set of disabled antennas.

At 906, the RU may transmit, based on the first indication and the second indication, a signal to a target wireless device. Transmitting the signal at 906, in some aspects, may include applying, at 907, the weight(s) in the second indication of the set of weights to the corresponding antenna(s) in the first set of activated antennas when transmitting the signal. For example, 906 and 907 may be performed by, RU processor(s) 1042, transceiver(s) 1046, antenna(s) 1080, and/or C-plane optimization component 199 of FIG. 10. For example, referring to FIG. 5, the RU 540 may transmit transmission 514 to the UE 504 based on a determination, at 512, of a set of transmission parameters for the transmission to the UE 504.

In some aspects, applying the weight(s) at 907 may include a process for identifying activated antennas and the corresponding weights indicated in the first and second indication (e.g., indicated by the combination of the first and second indications or by consideration/comparison of the first/second indication in light of the second/first indication). For example, at 908, the RU may begin the process by initializing a set of index variables (e.g., and index value i into the bitmap and an index value j into the set of weights) to 0 (e.g., where the list is indexed from 0 to a value that is one less than the length of the indication). The RU may then determine, at 909, if the i^{th} term of the bitmap indicates an activated antenna. If the RU determines at 909 that the i^{th} term of the bitmap indicates that the antenna is activated, the RU may, at 910, apply/assign (or associate) the j^{th} term in the set of weights (e.g., an I and Q weight pair) to (or with) the antenna corresponding and, at 911, increment the value of j. The RU may then determine, at 912, if index value i has reached a maximum value and, if the RU determines that the index value i has reached the maximum value, the RU may end the process having identified all the activated antennas and the corresponding weights in the set of weights. If the RU determines at 909 that the i^{th} term of the bitmap indicates that the antenna is disabled or determines at 912 that the index value i has not reached the maximum value, the RU may, at 913, increment the value i and return to determine, at 909, if the i^{th} term of the bitmap indicates an activated antenna until the maximum value for i (e.g., an index value associated with a last bit in the bitmap) has been reached (and a determination has been made for whether an antenna corresponding to the last bit is activated). For example, 908-913 may be performed by, RU processor(s) 1042, transceiver(s) 1046, antenna(s) 1080, and/or C-plane optimization component 199 of FIG. 10. In some aspects, other algorithms, processes, or methods may be used that allow the RU to match activated antennas identified in the first indication with weights in the set of weights included in (or indicated by) the second indication of the set of weights. For example, referring to FIG. 5, the RU 540 may determine, at 512, of a set of transmission parameters for the transmission 514 to the UE 504 based on the algorithm described in relation to FIG. 5, and based on the determined weights, the RU 540 may transmit, and the UE 504 may receive, a transmission 514.

FIG. 10 is a diagram 1000 illustrating an example of a hardware implementation for a network entity 1002. The network entity 1002 may be a BS, a component of a BS, or may implement BS functionality. The network entity 1002 may include at least one of a CU 1010, a DU 1030, or an RU 1040. For example, depending on the layer functionality handled by the C-plane optimization component 199, the network entity 1002 may include the CU 1010; both the CU 1010 and the DU 1030; each of the CU 1010, the DU 1030, and the RU 1040; the DU 1030; both the DU 1030 and the RU 1040; or the RU 1040. The CU 1010 may include at least one CU processor 1012. The CU processor(s) 1012 may include on-chip memory 1012′. In some aspects, the CU 1010 may further include additional memory modules 1014 and a communications interface 1018. The CU 1010 communicates with the DU 1030 through a midhaul link, such as an F1 interface. The DU 1030 may include at least one DU processor 1032. The DU processor(s) 1032 may include on-chip memory 1032′. In some aspects, the DU 1030 may further include additional memory modules 1034 and a communications interface 1038. The DU 1030 communicates with the RU 1040 through a fronthaul link. The RU 1040 may include at least one RU processor 1042. The RU processor(s) 1042 may include on-chip memory 1042′. In some aspects, the RU 1040 may further include additional memory modules 1044, one or more transceivers 1046, one or more antennas 1080, and a communications interface 1048. The RU 1040 communicates with the UE 104. The on-chip memory 1012′, 1032′, 1042′ and the additional memory modules 1014, 1034, 1044 may each be considered a computer-readable medium/memory. Each computer-readable medium/memory may be non-transitory. Each of the processors 1012, 1032, 1042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the C-plane optimization component 199 of a first network device (e.g., of the DU 1030 or of an O-DU) may be configured to identify, in a plurality of antennas at a second network device, a first set of activated antennas and a second set of disabled antennas and transmit, to the second network device, an indication of a set of weights, where each weight in the set of weights corresponds to an antenna in the first set of activated antennas and the set of weights does not include a weight corresponding to any antenna in the second set of disabled antennas. In some aspects, the C-plane optimization component 199 of a second network device (e.g., of the RU 1040 or of an O-RU) may be configured to receive, from a first network device, a first indication of a first set of activated antennas and a second set of disabled antennas in a plurality of antennas at the second network device and receive, from the first network device, a second indication of a set of weights, where each weight in the set of weights corresponds to an antenna in the first set of activated antennas and the set of weights does not include a weight corresponding to any antenna in the second set of disabled antennas. The C-plane optimization component 199 may be within one or more processors of one or more of the CU 1010, DU 1030, and the RU 1040. The C-plane optimization component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1002 may include a variety of components configured for various functions. In one configuration, the network entity 1002 may include means for identifying, in a plurality of antennas at a second network device, a first set of activated antennas and a second set of disabled antennas. In one configuration, the network entity 1002 may include means for transmitting, to the second network device, an indication of a set of weights. In one configuration, the network entity 1002 may include means for transmitting, to the second network device, a prior indication of the first set of activated antennas and the second set of disabled antennas. In one configuration, the network entity 1002 (e.g., a first network device) may include means for receiving, from a second network device, a first indication of a first set of activated antennas and a second set of disabled antennas in a plurality of antennas at the second network device. In one configuration, the network entity 1002 may include means for receiving, from the second network device, a second indication of a set of weights. In one configuration, the network entity 1002 may include means for transmitting, based on the first indication and the second indication, a signal to a target wireless device. In one configuration, the network entity 1002 may include means for applying each weight in the second indication to the corresponding antenna in the first set of activated antennas when transmitting the signal. In one configuration, the network entity 1002 may include means for identifying a first bit in the bitmap having the first value and a corresponding first activated antenna of the first set of activated antennas in the plurality of antennas. In one configuration, the network entity 1002 may include means for applying a first weight in the second indication of the set of weights to the corresponding first activated antenna. In one configuration, the network entity 1002 may include means for identifying, until a last bit in the bitmap, a next bit in the bitmap having the first value and a corresponding next activated antenna of the first set of activated antennas in the plurality of antennas. In one configuration, the network entity 1002 may include means for applying, until the last bit in the bitmap, a next weight in the second indication of the set of weights to the corresponding next activated antenna. The network entity 1002 may further include means for performing any of the aspects described in connection with the flowchart in FIGS. 6 to 9, and/or performed by the DU and/or the RU in the communication flow of FIG. 5. The means may be the C-plane optimization component 199 of the network entity 1002 configured to perform the functions recited by the means. As described supra, the network entity 1002 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to allowing the O-DU to send beamforming weights for activated antenna elements rather than sending weights for all antenna array elements, even the unused and/or disabled antenna array elements. Some aspects more specifically relate to transmitting a limited set of beamforming weights based on a control message identifying the activated and/or disabled antenna array elements (e.g., via an antenna mask (in an antMask[x:0] field) included in a Section Type 4 command type “TRX Control”). In some examples, a first network device may be configured to identify, in a plurality of antennas at a second network device, a first set of activated antennas and a second set of disabled antennas and transmit, to the second network device, an indication of a set of weights, where each weight in the set of weights corresponds to an antenna in the first set of activated antennas and the set of weights does not include a weight corresponding to any antenna in the second set of disabled antennas. In some aspects, a second network device may be configured to receive, from a first network device, a first indication of a first set of activated antennas and a second set of disabled antennas in a plurality of antennas at the second network device and receive, from the first network device, a second indication of a set of weights, where each weight in the set of weights corresponds to an antenna in the first set of activated antennas and the set of weights does not include a weight corresponding to any antenna in the second set of disabled antennas.

Particular aspects of the subject matter described in this disclosure can be implemented to realize one or more of the following potential advantages. In some examples, by allowing the O-DU to transmit a reduced set of beamforming weights for the O-RU based on an earlier control message, the described techniques can be used to significantly reduce a fronthaul load and/or overhead associated with signaling the beamforming weights.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network device, comprising: identifying, in a plurality of antennas at a second network device, a first set of activated antennas and a second set of disabled antennas; and transmitting, to the second network device, an indication of a set of weights, wherein each weight in the set of weights corresponds to an antenna in the first set of activated antennas and the set of weights does not comprise a weight corresponding to any antenna in the second set of disabled antennas.

Aspect 2 is the method of aspect 1, wherein each weight in the set of weights comprises an in-phase (I) weight and a quadrature (Q) weight associated with a corresponding antenna in the first set of activated antennas.

Aspect 3 is the method of any of aspects 1 and 2, further comprising: transmitting, to the second network device, a prior indication of the first set of activated antennas and the second set of disabled antennas, wherein the indication of the set of weights is based on the prior indication.

Aspect 4 is the method of aspect 3, wherein the indication of the set of weights has a size based on a number of antennas in the first set of activated antennas indicated in the prior indication.

Aspect 5 is the method of any of aspects 3 and 4, wherein the prior indication is included in a control message associated with a control plane.

Aspect 6 is the method of aspect 5, wherein the first network device comprises an open radio access network (O-RAN) distributed unit (DU) (O-DU) and the second network device comprises an O-RAN radio unit (RU) (O-RU).

Aspect 7 is the method of any of aspects 3 to 6, wherein: the prior indication comprises a bitmap corresponding to the plurality of antennas, a first value, for each bit in the bitmap, indicates that a corresponding antenna is an active antenna in the first set of activated antennas, and a second value, for each bit in the bitmap, indicates that the corresponding antenna is a disabled antenna in the second set of disabled antennas, and the indication of the set of weights comprises an ordered set of weights corresponding to bits in the bitmap having the first value.

Aspect 8 is a method of wireless communication at a first network device, comprising: receiving, from a second network device, a first indication of a first set of activated antennas and a second set of disabled antennas in a plurality of antennas at the first network device; and receiving, from the second network device, a second indication of a set of weights, wherein each weight in the set of weights corresponds to an antenna in the first set of activated antennas and the set of weights does not comprise a weight corresponding to any antenna in the second set of disabled antennas.

Aspect 9 is the method of aspect 8, wherein each weight in the set of weights comprises an in-phase (I) weight and a quadrature (Q) weight associated with a corresponding antenna in the first set of activated antennas.

Aspect 10 is the method of any of aspects 8 and 9, wherein the second indication of the set of weights is based on the first indication.

Aspect 11 is the method of aspects 8 to 10, wherein the second indication of the set of weights has a size based on a number of antennas in the first set of activated antennas indicated in the first indication.

Aspect 12 is the method of any of aspects 8 to 11, wherein the first indication is included in a control message associated with a control plane.

Aspect 13 is the method of any of aspects 8 to 12, wherein the second network device comprises an open radio access network (O-RAN) distributed unit (DU) (O-DU) and the first network device comprises an O-RAN radio unit (RU) (O-RU).

Aspect 14 is the method of any of aspects 8 to 13, further comprising: transmitting, based on the first indication and the second indication, a signal to a target wireless device.

Aspect 15 is the method of aspect 14, wherein: the first indication comprises a bitmap corresponding to the plurality of antennas, a first value, for each bit in the bitmap, indicates that a corresponding antenna is an active antenna in the first set of activated antennas, and a second value, for each bit in the bitmap, indicates that the corresponding antenna is a disabled antenna in the second set of disabled antennas, and the second indication of the set of weights comprises an ordered set of weights corresponding to bits in the bitmap having the first value.

Aspect 16 is the method of aspect 15, wherein transmitting the signal based on the first indication and the second indication comprises: applying each weight in the second indication to the corresponding antenna in the first set of activated antennas when transmitting the signal.

Aspect 17 is the method of aspect 16, wherein applying each weight comprises: identifying a first bit in the bitmap having the first value and a corresponding first activated antenna of the first set of activated antennas in the plurality of antennas; applying a first weight in the second indication of the set of weights to the corresponding first activated antenna; identifying, until a last bit in the bitmap, a next bit in the bitmap having the first value and a corresponding next activated antenna of the first set of activated antennas in the plurality of antennas; and applying, until the last bit in the bitmap, a next weight in the second indication of the set of weights to the corresponding next activated antenna.

Aspect 18 is an apparatus for wireless communication at a device including a memory and at least one processor coupled to the memory and, based at least in part on information stored in the memory, the at least one processor is configured to implement any of aspects 1 to 7.

Aspect 19 is the apparatus of aspect 18, further including a transceiver or an antenna coupled to the at least one processor.

Aspect 20 is an apparatus for wireless communication at a device including means for implementing any of aspects 1 to 7.

Aspect 21 is a computer-readable medium (e.g., a non-transitory computer-readable medium) storing computer executable code, where the code when executed by a processor causes the processor to implement any of aspects 1 to 7.

Aspect 22 is an apparatus for wireless communication at a device including a memory and at least one processor coupled to the memory and, based at least in part on information stored in the memory, the at least one processor is configured to implement any of aspects 8 to 17.

Aspect 23 is the apparatus of aspect 22, further including a transceiver or an antenna coupled to the at least one processor.

Aspect 24 is an apparatus for wireless communication at a device including means for implementing any of aspects 8 to 17.

Aspect 25 is a computer-readable medium (e.g., a non-transitory computer-readable medium) storing computer executable code, where the code when executed by a processor causes the processor to implement any of aspects 8 to 17.

What is claimed is:

1. An apparatus for wireless communication at a first network device, comprising:
at least one memory; and
at least one processor coupled to the at least one memory and, based at least in part on stored information that is stored in the at least one memory, the at least one processor, individually or in any combination, is configured to:
identify, in a plurality of antennas at a second network device, a first set of activated antennas and a second set of disabled antennas; and
transmit, to the second network device, an indication of a set of weights, wherein each weight in the set of weights corresponds to an antenna in the first set of activated antennas and the set of weights does not comprise a weight corresponding to any antenna in the second set of disabled antennas.

2. The apparatus of claim 1, wherein each weight in the set of weights comprises an in-phase (I) weight and a quadrature (Q) weight associated with a corresponding antenna in the first set of activated antennas.

3. The apparatus of claim 1, further comprising a transceiver coupled to the at least one processor, wherein the at least one processor, individually or in any combination, is further configured to:
transmit, to the second network device via the transceiver, a prior indication of the first set of activated antennas and the second set of disabled antennas, wherein the indication of the set of weights is based on the prior indication.

4. The apparatus of claim 3, wherein the indication of the set of weights has a size based on a number of antennas in the first set of activated antennas indicated in the prior indication.

5. The apparatus of claim 3, wherein, to transmit the prior indication, the at least one processor, individually or in any combination, is further configured to transmit a control message associated with a control plane that includes the prior indication.

6. The apparatus of claim 5, wherein the first network device comprises an open radio access network (O-RAN) distributed unit (DU) (O-DU) and the second network device comprises an O-RAN radio unit (RU) (O-RU).

7. The apparatus of claim 3, wherein:
the prior indication comprises a bitmap corresponding to the plurality of antennas,
a first value, for each bit in the bitmap, indicates that a corresponding antenna is an active antenna in the first set of activated antennas, and a second value, for each bit in the bitmap, indicates that the corresponding antenna is a disabled antenna in the second set of disabled antennas, and
the indication of the set of weights comprises an ordered set of weights corresponding to bits in the bitmap having the first value.

8. A method of wireless communication at a first network device, comprising:
identifying, in a plurality of antennas at a second network device, a first set of activated antennas and a second set of disabled antennas; and
transmitting, to the second network device, an indication of a set of weights, wherein each weight in the set of weights corresponds to an antenna in the first set of activated antennas and the set of weights does not comprise a weight corresponding to any antenna in the second set of disabled antennas.

9. The method of claim 8, wherein each weight in the set of weights comprises an in-phase (I) weight and a quadrature (Q) weight associated with a corresponding antenna in the first set of activated antennas.

10. The method of claim 8, further comprising:
transmitting, to the second network device, a prior indication of the first set of activated antennas and the second set of disabled antennas, wherein the indication of the set of weights is based on the prior indication.

11. The method of claim 10, wherein the indication of the set of weights has a size based on a number of antennas in the first set of activated antennas indicated in the prior indication.

12. The method of claim 10, wherein the prior indication is included in a control message associated with a control plane (C-Plane).

13. The method of claim 12, wherein the first network device comprises an open radio access network (O-RAN) distributed unit (DU) (O-DU) and the second network device comprises an O-RAN radio unit (RU) (O-RU).

14. The method of claim 10, wherein:
the prior indication comprises a bitmap corresponding to the plurality of antennas,
a first value, for each bit in the bitmap, indicates that a corresponding antenna is an active antenna in the first set of activated antennas, and a second value, for each bit in the bitmap, indicates that the corresponding antenna is a disabled antenna in the second set of disabled antennas, and
the indication of the set of weights comprises an ordered set of weights corresponding to bits in the bitmap having the first value.

15. An apparatus for wireless communication at a first network device, comprising:
at least one memory; and
at least one processor coupled to the at least one memory and, based at least in part on stored information that is stored in the at least one memory, the at least one processor, individually or in any combination, is configured to:
receive, from a second network device, a first indication of a first set of activated antennas and a second set of disabled antennas in a plurality of antennas at the first network device; and
receive, from the second network device, a second indication of a set of weights, wherein each weight in the set of weights corresponds to an antenna in the first set of activated antennas and the set of weights does not comprise a weight corresponding to any antenna in the second set of disabled antennas.

16. The apparatus of claim 15, wherein the second network device comprises an open radio access network (O-RAN) distributed unit (DU) (O-DU) and the first network device comprises an O-RAN radio unit (RU) (O-RU), wherein, to receive the first indication, the at least one processor, individually or in any combination, is further configured to receive a control message associated with a control plane that includes the first indication, wherein the second indication of the set of weights has a size based on a number of antennas in the first set of activated antennas indicated in the first indication, wherein each weight in the set of weights comprises an in-phase (I) weight and a quadrature (Q) weight associated with a corresponding antenna in the first set of activated antennas.

17. The apparatus of claim 15, further comprising a transceiver coupled to the at least one processor, wherein the at least one processor, individually or in any combination, is further configured to:
transmit, via the transceiver and based on the first indication and the second indication, a signal to a target wireless device.

18. The apparatus of claim 17, wherein:
the first indication comprises a bitmap corresponding to the plurality of antennas,
a first value, for each bit in the bitmap, indicates that a corresponding antenna is an active antenna in the first set of activated antennas, and a second value, for each bit in the bitmap, indicates that the corresponding antenna is a disabled antenna in the second set of disabled antennas, and
the second indication of the set of weights comprises an ordered set of weights corresponding to bits in the bitmap having the first value.

19. The apparatus of claim 18, wherein, to transmit the signal based on the first indication and the second indication, the at least one processor, individually or in any combination, is further configured to:
apply each weight in the second indication to the corresponding antenna in the first set of activated antennas when transmitting the signal.

20. The apparatus of claim 19, wherein, to apply each weight, the at least one processor, individually or in any combination, is further configured to:
identify a first bit in the bitmap having the first value and a corresponding first activated antenna of the first set of activated antennas in the plurality of antennas;
apply a first weight in the second indication of the set of weights to the corresponding first activated antenna;
identify, until a last bit in the bitmap, a next bit in the bitmap having the first value and a corresponding next activated antenna of the first set of activated antennas in the plurality of antennas; and
apply, until the last bit in the bitmap, a next weight in the second indication of the set of weights to the corresponding next activated antenna.
